(19) United States
(12) Patent Application Publication
(10) Pub. No.: US 2008/0247857 A1
(43) Pub. Date: Oct. 9, 2008

(54) End effector and robot for transporting substrate

(76) Inventors: Ichiro Yuasa, Shimotsuke (JP); Yuichi Maruyama, Tokyo (JP); Terukazu Toki, Kawachi (JP); Isao Fukazu, Haga (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/079,174

(22) Filed: Mar. 25, 2008

Related U.S. Application Data
(60) Provisional application No. 60/921,946, filed on Apr. 5, 2007.

(51) Int. Cl. B66F 11/00

(52) U.S. Cl. 414/680; 901/30

(57) ABSTRACT

An end effector of a substrate transport robot includes an upper plate made of fiber-reinforced plastic (FRP); a lower plate made of fiber-reinforced plastic (FRP); and an intermediate member arranged between the upper plate and the lower plate and selected from the group consisting of aluminum, stainless steel and honeycomb-shaped fiber-reinforced plastic (FRP). Further, a substrate transport robot is equipped with the above end effector.

This application claims the benefit of U.S. Provisional Application No. 60/921,946, filed Apr. 5, 2007, which is incorporated herein by reference in its entirety.

### BACKGROUND OF THE INVENTION

1. Field of the Invention

The present invention relates to an end effector that is a constituent member of a robot that transports various types of substrates such as glass substrates used in liquid crystal displays. The present invention also relates to a robot comprising said end effector.

2. Description of the Related Art

The size of glass used in the production of liquid crystal displays has recently become larger accompanying the increased size of liquid crystal displays. Although substrate transport robots providing an end effector that holds substrates is used when transporting glass substrates, these robots are also tending to become larger. A transport member used in a robot that transports semiconductor wafers and liquid crystal substrates is disclosed in U.S. Pat. No. 6,893,712 and is an example of a technology relating to an end effector and substrate transport robot.

Although U.S. Pat. No. 6,893,712 discloses an end effector combining a plurality of carbon fiber-reinforced plastics, in the case of applying this technology to the holding of large-sized glass substrates, referred to as eighth generation substrates, there is the problem of bending of the end effector in particular.

It can be desirable to use end effectors that can hold large-sized substrates. It can also be desirable to equip a substrate transport robot with such end effectors for the purpose of transporting large-sized substrates, particularly large-sized glass for liquid crystalline displays.

### SUMMARY OF THE INVENTION

An object of the present invention is to provide an end effector that is thin, is resistant to bending, is lightweight and can be adequately used to hold large-sized glass substrates referred to as eighth generation substrates, and a substrate transport robot equipped with said end effector. In addition, an object of the present invention is to provide a means for easily producing a long end effector.

The present invention is an end effector of a substrate transport robot, comprising an upper plate made of fiber-reinforced plastic (FRP), a lower FRP plate, and an intermediate member arranged between the upper plate and the lower plate and comprising a material selected from the group consisting of aluminum, stainless steel and honeycomb-shaped FRP. The fiber is preferably a carbon fiber, an aramid fiber or a polyparaphenylene benzobisoxazole fiber.

In addition, the present invention relates to a substrate transport robot equipped with the aforementioned end effector.

The end effector of the present invention is comprised of an upper plate, a lower plate and an intermediate member arranged there between. This type of end effector has a simpler structure than end effectors comprised only of carbon fiber-reinforced materials. In addition, it also enables production costs to be reduced. For example, the production process of a cylindrical end effector can be complex. Production is particularly difficult in the case of producing end effectors for use with eighth generation substrates and the like. With respect to this point, the end effector of the present invention can be produced by simply laminating plate-shaped members, thereby making the production process extremely simple. Depending on the case, the upper plate, lower plate and intermediate member can be transported to a liquid crystal panel production plant and assembled within the plant to conveniently produce the end effector.

In addition, the end effector of the present invention is a composite comprised of upper and lower plates comprising fiber-reinforced plastic, and an intermediate member made of aluminum, stainless steel or honeycomb-shaped fiber-reinforced plastic. In the case of using an intermediate member having different characteristics in this manner, vibration attenuation characteristics can be enhanced as compared with end effectors composed only of carbon fiber composite materials. Accordingly, contact between glass substrates during bending of the end effector can be effectively prevented. This characteristic is particularly useful in long end effectors such as those used for eighth generation substrates.

Moreover, the end effector of the present invention employs a carbon fiber composite material or reinforcing fibers for the upper and lower plates. Consequently, an end effector can be provided that is both lightweight and thin.

In addition, the substrate transport robot of the present invention can be preferably used to transport glass substrates in a liquid crystal display production process due to each of the effects of thinness, inhibition of bending and reduced weight of the aforementioned end effector. The substrate transport robot of the present invention is particularly preferable for holding large-sized glass substrates referred to as eighth generation substrates due to the extremely high bending inhibitory effects described above. However, the present invention is not limited to eighth generation substrates, but rather can naturally also be applied to other sizes of glass substrates and substrates other than glass substrates.

### BRIEF DESCRIPTION OF THE DRAWINGS

FIG. 1A is a perspective view, FIG. 1B an overhead view and FIG. 1C a side view of an end effector 12 as an example of the present invention;

FIG. 2A is a side view and FIG. 2B is a front view of an example of an end effector of the present invention in which the intermediate member is a hollow rectangular prism;

FIG. 3A is an overhead view, FIG. 3B is a side view and FIG. 3C is a back view of an example of an end effector of the present invention in which the intermediate member is a U-shaped member;

FIG. 4A is an overhead view, FIG. 4B is a side view and FIG. 4C is a front view of an example of an end effector of the present invention in which the intermediate member is made of honeycomb-shaped aramid fibers;

FIG. 5 is a schematic perspective view of an example of a substrate transport robot 30 equipped with an end effector of the present invention.

### DESCRIPTION OF THE PREFERRED EMBODIMENTS

The following provides a detailed explanation of an end effector and substrate transport robot of the present invention with reference to the drawings.

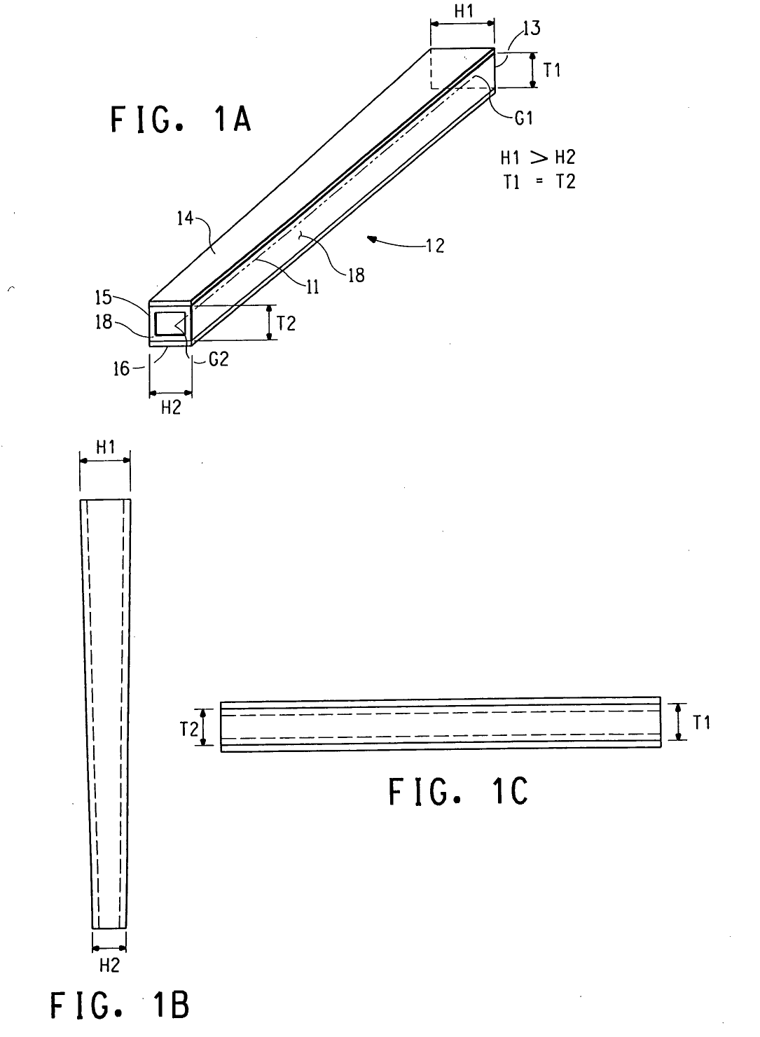

FIG. 1 shows an end effector 12 as an example of the present invention. FIG. 1A is a perspective view, FIG. 1B an overhead view, and FIG. 1C a side view. In this example, an end effector 12 is comprised of an upper plate 14 made of fiber-reinforced plastic (sometimes simply referred to as FRP hereinafter), a lower plate 16 made of FRP, and an intermediate member 18 arranged between the upper plate 14 and the lower plate 16 selected from the group consisting of aluminum, stainless steel and honeycomb-shaped FRP, and has a hollow structure overall. Furthermore, although the example of FIG. 1 is an example of a hollow structure, the end effector of the present application is not limited to this shape, but can also employ a solid structure.

There are no particular limitations on the composition of the FRP serving as the material of the upper plate 14 and the lower plate 16, and a wide range of materials known as FRP can be applied. Two or more types of these materials may also be used in combination. Carbon fibers, aramid fibers or polyparaphenylene benzobisoxazole fibers are preferably used for the reinforcing fibers incorporated in the plastic. These materials are available commercially, and may be formed into the shape of a plate using a commercially available material as a base. Examples of commercially available materials include Kevlar® and Zylon®. Those fibers that are lighter and improve characteristics contributing to resistance to bending are used preferably. For example, a carbon fiber-reinforced plastic (CFRP) containing carbon fibers in the form of highly elastic carbon fibers having a tensile elastic modulus of 490 to 950 GPa at 30% or more by volume is used. By making the volume ratio of these fibers 30% or more of the total volume of the CFRP, adequate rigidity is obtained and a member having high vibration attenuation characteristics is obtained. The aforementioned volume ratio is preferably 40% or more.

Although all of the reinforcing fibers used may be highly elastic carbon fibers, a portion of the fibers may be made of other reinforcing fibers such as carbon fibers having a tensile elastic modulus of less than 490 GPa, glass fibers, aramid fibers, silicon carbide fibers or other known reinforcing fibers. For example, the volume ratio of highly elastic carbon fibers may be up to 90%, while other reinforcing fibers, and particularly carbon fibers having a tensile elastic modulus of less than 490 GPa, can be used in combination therewith for the remainder of the fibers.

In addition, a material selected from the group consisting of aluminum, stainless steel and honeycomb-shaped FRP is used for the intermediate member 18 arranged between the upper plate 14 and the lower plate 16. Aluminum and stainless steel have high strength and are resistant to corrosion.

There are no particular limitations on the reinforcing fibers serving as the material of the intermediate member, and a wide range of materials known to be reinforcing fibers can be applied. Carbon fibers, aramid fibers or polyparaphenylene benzobisoxazole fibers are preferably used for the reinforcing fibers incorporated in the plastic. These materials are available commercially, and may be formed into the shape of a plate using a commercially available material as a base. Examples of commercially available materials include Kevlar® and Zylon®. Those fibers that are lighter and improve characteristics contributing to resistance to bending are used preferably. For example, a carbon fiber-reinforced plastic (CFRP) containing carbon fibers in the form of highly elastic carbon fibers having a tensile elastic modulus of 490 to 950 GPa at 30% or more by volume is used. By making the volume ratio of these fibers 30% or more, adequate rigidity is obtained and a member having high vibration attenuation characteristics is obtained. The aforementioned volume ratio is preferably 40% or more.

The following provides an explanation of various aspects of the end effector of the present invention, and particularly aspects in which the intermediate member has been suitably altered.

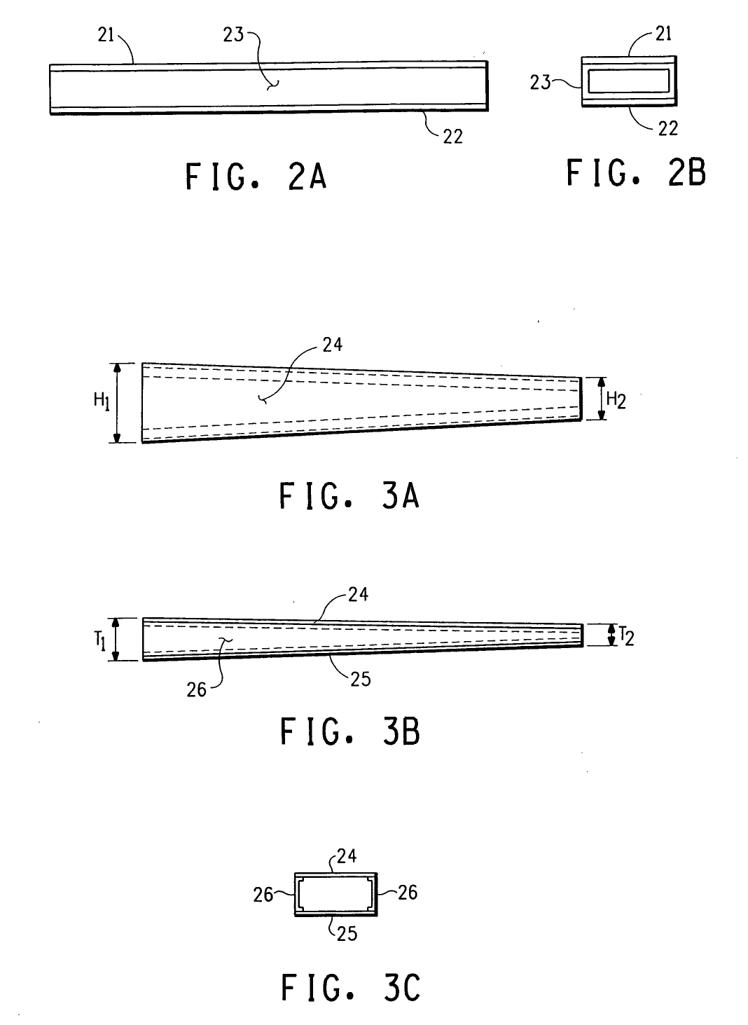

FIG. 2A is a side view and FIG. 2B is a front view (as viewed from the side of FIG. 2A) of one aspect of an end effector of the present invention. In this example, the end effector is constituted by an upper plate 21, a lower plate 22 and a hollow rectangular prism intermediate member 23 arranged between these plates 21 and 22. The use of an intermediate member of this form makes it possible for the entire end effector to demonstrate light weight, adequate strength and bending rigidity.

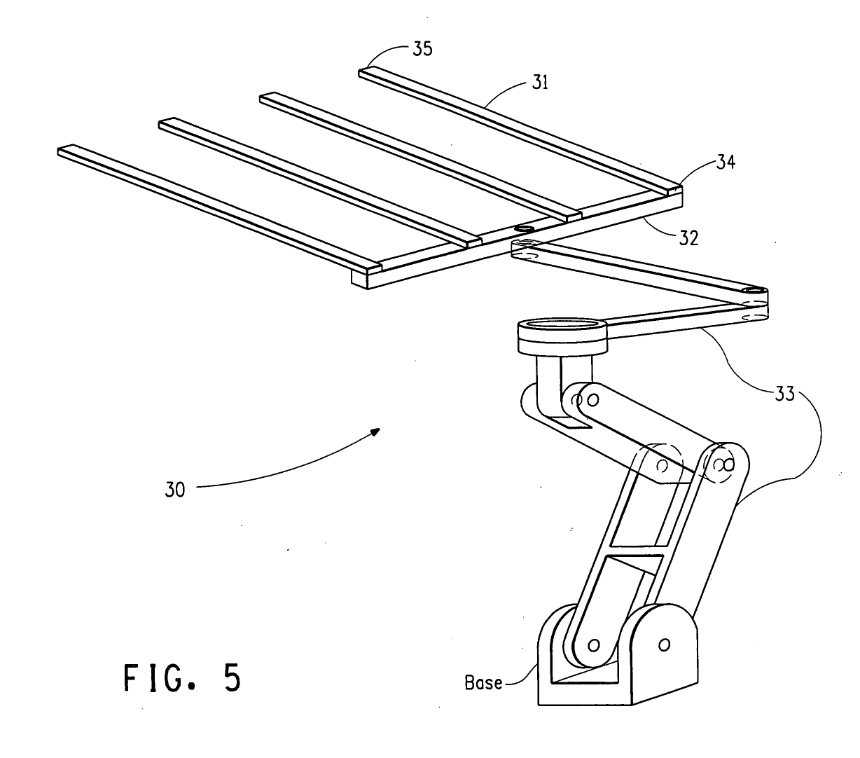

FIG. 3A is an overhead view, FIG. 3B is a side view and FIG. 3C is a back view (as viewed from the left side of FIG. 3B) of one aspect of an end effector of the present invention. In this example, the end effector is constituted by an upper plate 24, a lower plate 25 and a U-shaped intermediate member 26 arranged between these plates 24 and 25. The use of an intermediate member of this form makes it possible to reduce the weight of the end effector in comparison with the example shown in FIG. 2 since the volume of the intermediate member can be made to be smaller. In addition, in the case of end effectors extending in a single direction as in the substrate robot shown in FIG. 5 to be described later, the effect of reducing bending of the end of the end effector is large.

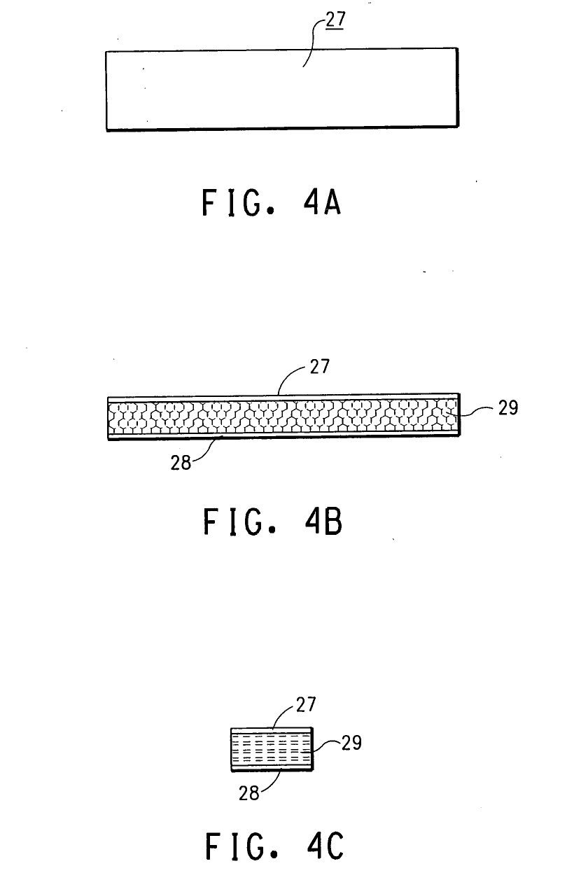

FIG. 4A is an overhead view, FIG. 4B is a side view and FIG. 4C is a front view (as viewed from the side of FIG. 4B) of one aspect of an end effector of the present invention. In this example, the end effector is constituted by an upper plate 27, a lower plate 28 and an intermediate member 29 made of honeycomb-shaped aramid fibers arranged between these plates 27 and 28. The use of this type of intermediate member makes it possible to reduce the weight of the end effector at an extremely high level. Since aramid fibers have roughly five times the strength of ordinary steel wire, are lightweight, and have superior heat resistance and impact resistance, they are particularly advantageous for use as intermediate member 29.

As shown in FIG. 1, in the case of adopting a hollow structure for the entirety of end effector 12, it is preferable that the fixed end 13 of the end effector have a structure in which the outer circumference of the cross-section that is perpendicular to the lengthwise direction of the end effector becomes smaller moving from the fixed end 13 towards the free end 15 in order to obtain higher vibration attenuation characteristics. Here, the “lengthwise direction” refers to the direction of a line 11 that connects the cross-sectional center of gravity (G1) of the fixed end 13 and the cross-sectional center of gravity (G2) of the free end 15 of hollow end effector 12 shown in FIG. 1.

In end effector 12 shown in FIG. 1, in the case of defining the width and height of the fixed end 13 as H1 and T1, respectively, and the width and height of the free end 15 as H2 and T2, respectively, end effector 12 has a tapered shape in which only the width becomes narrower moving towards the free end (H1>H2, T1=T2). However, the end effector of the present invention is not limited to this shape. In addition to end effector 12 having the shape shown in FIG. 1, an end effector of the present invention can also adopt a tapered shape in which, for example, only the thickness becomes smaller moving towards the free end (H1=H2, T1>T2). Moreover, an end effector of the present invention can also have a tapered shape in which both the width and height become smaller moving towards the free end (H1>H2, T1>T2 as illustrated in FIGS. 3A and 3B).

When the outer circumference of end effector 12 becomes smaller moving towards the free end 15, in order to reduce the amplitude during initial vibration, the outer circumference of the free end 15 of end effector 12 is preferably ⅓ or more, and more preferably ½ or more, the outer circumference of the fixed end 13. On the other hand, in order to demonstrate effects with respect to vibration attenuation characteristics by reducing the outer circumference of the free end 15 even a little as compared with an end effector having the same outer circumference for the fixed and free ends, the outer circumference of the free end 15 is preferably 9/10 or less, and more preferably ⅗ or less, the outer circumference of the fixed end 13. Therefore, the outer circumference of the free end 15 is preferably from ⅓ to 9/10 that of the fixed end 15 and, more preferably, the outer circumference of the free end 15 is from ½ to ⅗ that of the fixed end 15.

In addition, an aspect in which the outer circumference becomes smaller moving in the direction towards the free end is not limited to an aspect in which the outer circumference decreases uniformly from the fixed end 13 towards the free end 15 as shown in FIG. 1. For example, an aspect may be employed in which the outer circumference does not change at a portion near the fixed end 13 and then gradually becomes smaller beyond that portion moving towards the free end 15, or an aspect may be employed in which the outer circumference decreases up to an intermediate portion in the lengthwise direction, and then remains constant after that section moving towards the free end 15. Various other such aspects can be employed.

Furthermore, although not shown in the drawings, the end effector of the present invention may be of a shape in which both the widths and heights of the fixed end and the free end are of the same dimensions, i.e. H1=H2, T1=T2 so that the cross-section of the end effector is uniform and does not change from the fixed end to the free end.

The free of end of end effector 12 may remain open as shown in FIG. 1, or a cap made of rubber or other elastic member may be inserted into the end of the opening.

Moreover, the length of the end effector 12 shown in FIG. 1 should be such that the end effector is able to support a substrate so that bending of the central portion is inhibited when the substrate is housed in a substrate robot to be described later. Consequently, this length may be suitably determined according to the size of the substrate to be housed. In the present invention, the effects demonstrated by the present invention become increasingly prominent the greater the length of end effector 12. In particular, the present invention is extremely useful in the case in which the length of the end effector is 500 mm or more, preferably 1000 mm or more, and more preferably 2300 mm or more. There are no particular limitations on the width of end effector 12, and the minimum width is to be secured that allows the required strength and bending rigidity to be maintained for inhibiting bending of the central portion of the housed substrate corresponding to the manner in which the materials used are combined. In addition, the height can also be suitably set so that the minimum required strength and bending rigidity are able to be secured based on the relationship with width within the range of the pitch at which the substrates are housed. Typically, the height of the end effector of the present invention is 5 to 60 mm. The light weight and strong end effector is provided in the present invention. Typically the weight of the end effector is, but not limited to, 1 to 4 kg.

The end effector preferably shows little flexibility. Specifically, when 1 kg weight is put on the free end, the deflection in bending is preferably less than 20 mm, more preferably less than 10 mm.

As shown in FIG. 1, the end effector 12 having a constitution like that indicated above is comprised of, for example, an upper plate 14, a lower plate 16 and an intermediate member 18 arranged there between. The end effector can be produced easily by employing this type of constitution. In addition, the upper plate 14 and the lower plate 16 of said end effector 12 are made of FRP having high vibration attenuation characteristics, and aluminum, stainless steel or honeycomb-shaped FRP is chosen for the intermediate member, enabling enhancement of bending inhibitory effects. Moreover, the end effector of the present invention ensures light weight. In the case the intermediate member is hollow, an end effector can be provided which has even lighter weight and less bending (deformation).

The following provides an explanation of a production method of the end effector of the present invention by focusing particularly on an example of a method for producing a tapered, hollow end effector as shown in FIG. 1. The fact that end effectors having other shapes can also be produced by suitably altering the method described below can be easily understood by a person with ordinary skill in the art.

First, as a preliminary step, carbon fiber composite materials are prepared for the upper and lower plates, and an aluminum structure is prepared for the intermediate member.

Formation of Upper and Lower Plates The carbon fiber composite material used for the upper and lower plates is formed in the manner described below. First, a matrix resin is impregnated into a carbon fiber sheet to form an uncured pre-impregnated (prepreg) sheet. This prepreg sheet, for example, preferably uses highly elastic carbon fibers having a tensile elastic modulus of 490 to 950 GPa at 30% by volume or more. In addition, glass fibers or other fibers can also be added to the carbon fiber composite material provided they do not impair the support performance of the upper and lower plates.

Thermosetting resins such as epoxy resin, phenolic resin, cyanate resin, unsaturated polyester resin, polyimide resin, and bismaleimide resin can be used for the matrix resin. In this case, that which is able to withstand high temperature and high humidity environments such as rubber vulcanization is preferable. In addition, a thermosetting resin in which fine particles made of rubber or resin have been added to a thermosetting resin for the purpose of imparting impact resistance and toughness, or a thermosetting resin in which a thermoplastic resin has been dissolved in a thermosetting resin may also be used for the thermosetting resin.

Although types of carbon fibers include PAN-based carbon fibers (obtained from polyacrylonitrile—PAN-fiber) having a tensile elastic modulus of less than 490 GPa and pitch-based carbon fibers (obtained from petroleum or coal tar based precursors) having a tensile elastic modulus of 490 to 950 GPa, these can be used in combination in the present invention. In this case, the pitch-based fibers have the characteristic of a high elastic modulus, while the PAN-based fibers have the characteristic of high tensile strength. In addition, examples of prepreg sheets include unidirectional sheets in which the reinforcing fibers are oriented in the same direction, and cross-woven sheets such as flat weaves, twill weaves, satin weaves and triaxial weaves. Unidirectional sheets are particularly preferable for highly elastic carbon fiber prepreg sheets having a tensile elastic modulus of 490 to 950 GPa.

Various types of prepreg sheets can be prepared, such as those having different types of reinforcing fibers, those having different usage ratios of reinforcing fibers to the matrix resin, or those having different orientations of reinforcing fibers. Consequently, the prepreg sheet to be used is preferably suitably selected according to the glass substrates to be held so that end effectors having the optimum bending rigidity are formed.

The outer surface of the prepreg sheet may be covering with a cross-woven prepreg sheet as necessary. A cross-woven prepreg sheet refers to an uncured sheet in which the above-mentioned matrix resin is impregnated into reinforcing fibers woven in a plurality of directions. Woven carbon fibers, glass fibers, aramid fibers or silicon carbide fibers and so on are preferably used for the reinforcing fibers. In addition, a flexible, highly adhesive sheet is preferable so as to be able to closely adhere to and coat the prepreg sheet. Coating can be carried out closely adhering to the prepreg sheet while applying heat with an iron and so on.

As a result of coating with this cross-woven prepreg sheet, fluffing or unraveling and similar undesired results are prevented during post-processing such as cutting and boring. Thus, the use of a cross-woven prepreg sheet offers the advantages of not only improving processability, but also reducing the generation of debris without risk of damaging liquid crystal display substrates, plasma display substrates, silicon wafers or other precision substrates.

Next, the prepreg sheet is formed into a prepreg sheet section of predetermined dimensions. The shape of this prepreg sheet section is, for example, the shape of upper plate 14 and lower plate 16 shown in FIG. 1. The method used to form the prepreg sheet section can be by cutting, by mechanical processing or processing by a laser.

The uncured prepreg sheet section obtained in this manner is placed in a vacuum bag and then heated in an oven or similar apparatus while applying pressure to obtain the upper and lower plates. Heating conditions in this case consist of heating from room temperature at the rate of 2 to 10° C. per minute, holding at a temperature of about 100 to 190° C. for about 10 to 180 minutes, and then discontinuing heating and returning to room temperature by natural cooling. The purpose of placing the uncured prepreg section in a vacuum bag is to apply external pressure (namely, atmospheric pressure) to the uncured members roughly uniformly.

Formation of Intermediate Member

The material used for the intermediate member preferably has superior corrosion resistance in the manner of aluminum, stainless steel or honeycomb-shaped FRP. Aluminum is used preferably to realize a greater weight reduction of the end effector than can be realized with stainless steel. In addition, in the case of desiring an even greater reduction in weight, a honeycomb-shaped FRP (such as that containing aramid fibers) is used preferably instead of aluminum.

These metal materials or FRP are formed into members of prescribed dimensions using known forming methods to obtain the intermediate member. For example, they may be formed into the intermediate member 18 as shown in FIG. 1. Forming may be carried out by cutting, by mechanical processing or processing by a laser.

Formation of End Effector

The end effector is formed according to known forming methods using the upper plate, lower plate and intermediate member obtained in the manner described above. The end effector can be formed by, for example, by adhering these members. A two-liquid mixed type of epoxy adhesive, for example, can be used for the adhesive. Although there are no particular limitations on the adhesion conditions, an adhesive that can be cured at room temperature is used preferably in consideration of workability.

An end effector obtained in this manner can be manufactured easily as previously explained. In addition, since the end effector is in the form of a composite member with the upper plate, lower plate and other members, the entire end effector has the effect of inhibiting bending. Consequently, bending generated by vibration of the end effector is inhibited, thereby making it possible to effectively prevent contact between glass substrates during bending of the end effector. Moreover, further weight reduction of the end effector can be realized by using the above-mentioned materials and a hollow structure for the upper and lower plates.

In addition, it is not necessary to form an end effector 12 like that shown in FIG. 1 by going through a complex production process, such as wrapping numerous layers of a non-vulcanized sheet at predetermined angle relative to a core, as in the case of forming cylindrical end effectors. Consequently, the production efficiency of the end effector can be improved dramatically. As a result, end effectors can be produced both easily and inexpensively.

Although the above has provided an explanation relating to an end effector of the present invention, the following provides an explanation of a substrate transport robot that uses this type of end effector.

FIG. 5 is a schematic perspective view of an example of a substrate transport robot 30 equipped with an end effector of the present invention. The substrate transport robot 30 is comprised of end effectors (fingers) 31, a wrist 32 and arms 33. Each of the end effectors 31 has a fixed end 34 attached to the wrist 32 and a free end 35. Substrates are transported by being placed on the end effectors 31.

The end effector of the present invention is useful for transporting glass substrates used in the production process of liquid crystal displays as a result of demonstrating each of the effects of thinness, inhibition of bending and light weight. Moreover, the end effector of the present invention can be manufactured easily. In addition, the robot of the present invention handling substrate is particularly useful for transporting large-sized glass substrates referred to as 8th generation substrates.

What is claimed is:

1. An end effector of a substrate transport robot, comprising:
an upper plate made of fiber-reinforced plastic (FRP);
a lower plate made of fiber-reinforced plastic (FRP); and
an intermediate member arranged between the upper plate and the lower plate and comprising a material selected from the group consisting of aluminum, stainless steel and honeycomb-shaped fiber-reinforced plastic (FRP).

2. The end effector according to claim 1, wherein the fiber of the FRP is a carbon fiber, an aramid fiber or a polyparaphenylene benzobisoxazole fiber.

3. The end effector according to claim 2, wherein the fiber of the FRP is a carbon fiber having a tensile elastic modulus of 490 to 950 GPA and the volume of the fiber is 30% or more of the total volume of the FRP.

4. The end effector according to claim 3, wherein the volume of the fiber is 40% or more of the total volume of the FRP.

5. The end effector according to claim 1, wherein the end effector has a fixed end attached to the substrate transport robot and a free end and a cross-section that is perpendicular to the lengthwise direction of the end effector and wherein the end effector has a hollow structure, the outer circumference of the cross-section becomes smaller moving from the fixed end towards the free end.

6. The end effector according to claim 5, wherein the outer circumference of the free end is from ⅓ to 9/10 that of the fixed end.

7. The end effector according to claim 6, wherein the outer circumference of the free end is from ½ to ⅗ that of the fixed end.

8. A substrate transport robot equipped with the end effector of claim 1.

9. A substrate transport robot equipped with the end effector of claim 2.

10. A substrate transport robot equipped with the end effector of claim 3.

11. A substrate transport robot equipped with the end effector of claim 5.
